(19) United States
(12) Patent Application Publication
(10) Pub. No.: US 2007/0276922 A1
(43) Pub. Date: Nov. 29, 2007

(54) System and Method for Learning Including a Book with a Jump Drive

(76) Inventor: Donald Spector, New York, NY (US)

Correspondence Address: Glen M. Diehl;DIEHL SERVILLA LLC, Suite 110, 77 Brant Ave., Clark, NJ, 07066, US

(21) Appl. No.: 11/467,315

(22) Filed: Aug. 25, 2006

Related U.S. Application Data
(63) Continuation-in-part of application No. 11/464,894, filed on Aug. 16, 2006.
Application No. 11/464,894 is a continuation-in-part of application No. 11/440,934, filed on May 25, 2006.

(51) Int. Cl. G06F 15/16

(52) U.S. Cl. 709/217

(57) ABSTRACT

A book with a USB connection is provided. The book also has a memory and optionally a processor. One or more documents are stored in the memory. When the book is connected to a personal computer, the documents can be displayed on the personal computer. The documents can be modified and stored on the memory in the book for later use by the book's owner. A server can also be connected to the personal computer and the progress of a plurality of students with books can be monitored. Educational systems and methods are also disclosed.

### STATEMENT OF RELATED CASES

This application is a continuation-in-part of U.S. patent application Ser. No. 11/464,894, filed Aug. 16, 2006, which is a continuation-in-part of U.S. patent application Ser. No. 11/440,934, filed May 25, 2006, both of which are hereby incorporated by reference.

### FIELD OF THE INVENTION

This application relates to the field of books and to educational systems and methods.

### BACKGROUND OF THE INVENTION

Learning from a text book can be difficult and limiting. People learn through different mechanisms. Some people simply read and remember, others need to take copious notes from a text book to learn. Others learn better through visual and pictorial presentations of information. A simple text book does not offer a full range of teaching mechanisms that can be helpful to students. Also, it can be difficult to organize all of the additional references or information obtained from sources other than the textbook.

Long distance educational systems and methods can also be difficult to implement. It is difficult to track the progress of various students.

Accordingly, new and improved books and educational systems and methods are needed.

### DESCRIPTION OF THE DRAWINGS

FIG. 1 illustrates a book and an educational system in accordance with one aspect of the present invention.

FIG. 2 illustrates a circuit on a book in accordance with an aspect of the present invention.

FIG. 3 illustrates a plurality of documents stored on a memory on the book in accordance with a further aspect of the present invention.

FIG. 4 illustrates a roster of students used to monitor the progress of students at a server in accordance with an aspect of the present invention.

FIG. 5 illustrates another circuit that can be located on a book in accordance with a further aspect of the present invention.

FIGS. 6 and 7 illustrate a book with a jump drive or a USB device in accordance with another aspect of the present invention.

FIG. 8 illustrates the book of FIGS. 6 and 7 connected to a computing device.

FIG. 9 illustrates another aspect of the present invention wherein a content server and an advertising server are connected to a printed publication.

FIG. 10 illustrates another aspect of the present invention.

### SUMMARY OF THE INVENTION

One aspect of the present invention is an article that includes a book, a memory on the book and a connector on the book electronically connected to the memory and capable of providing an interface to a computer.

In accordance with another aspect of the present invention, the connector is a USB connector. In accordance with a further aspect of the present invention, the book has a spine and the USB connector is on the spine.

In accordance with yet another aspect of the present invention, one or more documents related to the contents of the book are stored in the memory. The documents include a worksheet related to the book, problems related to the book and/or notes related to the book. The notes can be generated by a user.

In accordance with a further aspect of the present invention, the book also includes a processor connected to the memory and the connector.

The present invention also contemplates an application being stored on the memory and is operable on the processor to instruct a personal computer.

The present invention also contemplates an educational system that includes a personal computer and a book having a memory and a connector capable of being connected to the personal computer, with one or more documents stored on the memory. When the book is connected to the personal computer through the connector, the one or more documents are transferred from the memory to the personal computer.

In accordance with another aspect of the present invention, an object from the personal computer can be stored on the memory on the book. The object can be a modified version of one of the one or more documents.

The one or more documents can be selected from the group consisting of: worksheets, problems, notes generated by a user, and/or combinations thereof.

In accordance with further aspects of the invention, the system further includes a server connected to the personal computer, wherein the personal computer can transfer the one or more documents to the server and the server monitors a user's progress through the book. The server can also transfer the one or more documents to the personal computer.

The present invention also contemplates an educational method that includes the steps of transferring a document from a book to a personal computer, transferring the document form the personal computer to a server and monitoring a user's progress through the book at the server based on the document. The documents can be selected from the group consisting of: worksheets, problems and notes generated by a user. The present invention also includes transferring a modified version of the document from the personal computer to the book.

### DESCRIPTION OF A PREFERRED EMBODIMENT

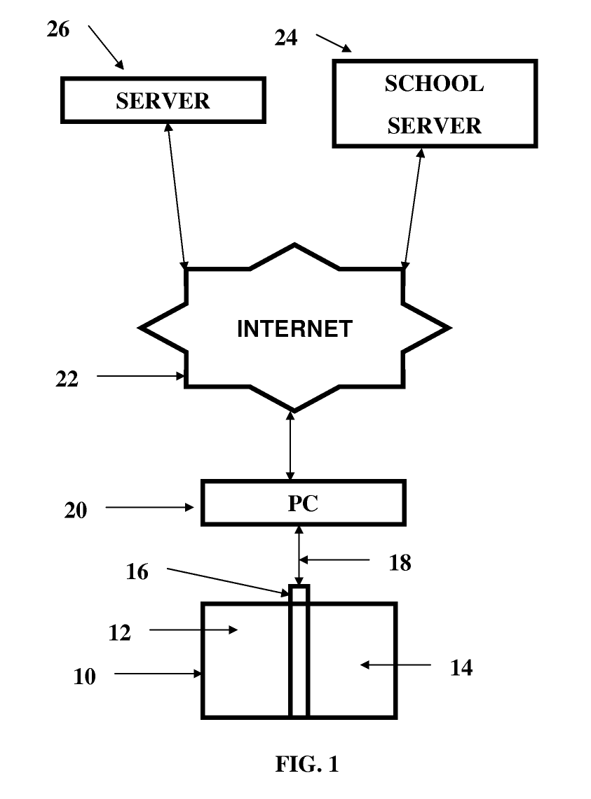

FIG. 1 illustrates an education system. The system includes a book 10 having a left side 12, a right side 14 and a spine 15. A connector 16 is attached to the book 10, preferably on the spine 15 of the book 10, although it can be attached anywhere on the book 10.

The connector 16 is preferably a USB connector.

A cable 18 can connect the book 10 to a personal computer 20. The personal computer 20 is connected to a network, such as the internet 22. A plurality of servers 26 are connected to the internet 22. A school's server 24 is also connected to the internet 22. Thus, the servers 24 and 26 are connected to the book 10 through the internet 22 and the personal computer 20.

Any type of connector 16 can be used. For example, the connector 16 can be a wireless transceiver that connects to a personal computer 20. While the connection—by wire or wireless—can be made directly to the personal computer 20, it can also connect to another personal computer via the internet 22 or to any server 26 on the internet.

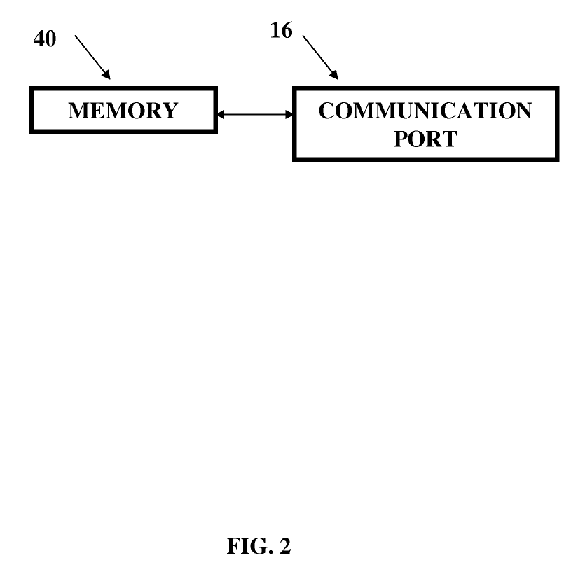

FIG. 2 illustrates a circuit that is located on the book 10 in accordance with one aspect of the present invention. The book 10 preferably has a memory 40 that is connected to a connector or communication port 16. In accordance with one aspect of the present invention, one or more documents related to the contents of the book are stored in the memory 40.

The memory 40 can also be located on the spine 15 of the book 10. The memory 40 and the connector 16 can be attached by an adhesive or by other means. For example, the memory 40 and the connector 16 can be attached inside a cover of the book 10 by adhesive. The can also be attached to a special page or to an insert during the manufacturing process.

The one or more documents can include a worksheet related to the book 10. They can also include problems related to the book. They can also include notes related to the book. Typically, the notes are generated by a user on a personal computer 20 when the user is reading the book or other sources and the notes can be stored on the memory 40 of the book 10. The notes can be stored as a template in the memory 40 for use by a user.

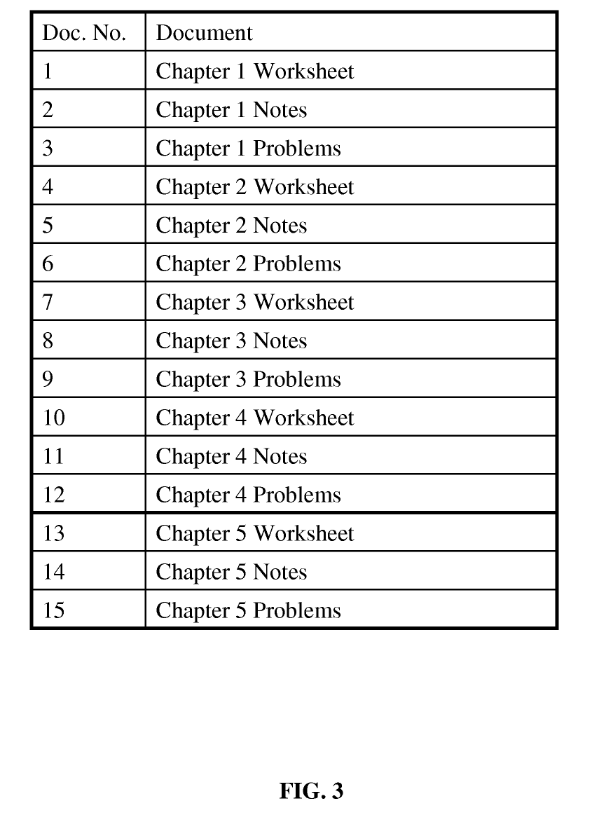

An example of the one or more documents stored on the memory 40 is illustrated in FIG. 3. There are fifteen documents stored on the memory. The first document is a worksheet based on the contents of chapter 1 in the book 10. The worksheet is a programmed review of the contents of chapter 1. The second document is notes from chapter 1 of the book 10. The document can be a blank document or it can be in template form. The notes document can be modified by a user, typically on the personal computer 20 and then stored on the memory 40 of the book 10 in a modified form. The third documents are problems related to the contents of chapter 1 of the book 10. Documents 4 to 15 are similar documents relating to chapters 2 to 5 of the book 10.

The documents from the memory 40 on the book 10 can be used, manipulated and modified by an owner of the book 10 while studying the book. Typically, the owner would use the documents on the personal computer 20 and store the documents, as modified, on the memory 40 in the book 10.

The documents can also be sent by the personal computer 20 to the school server 24 once they are completed by an owner of the book 10. The school server 24 can check on the progress of the book owner. If the book owner is a student in a class at the school, the school can conduct effective long distance learning by checking the progress of the book owner.

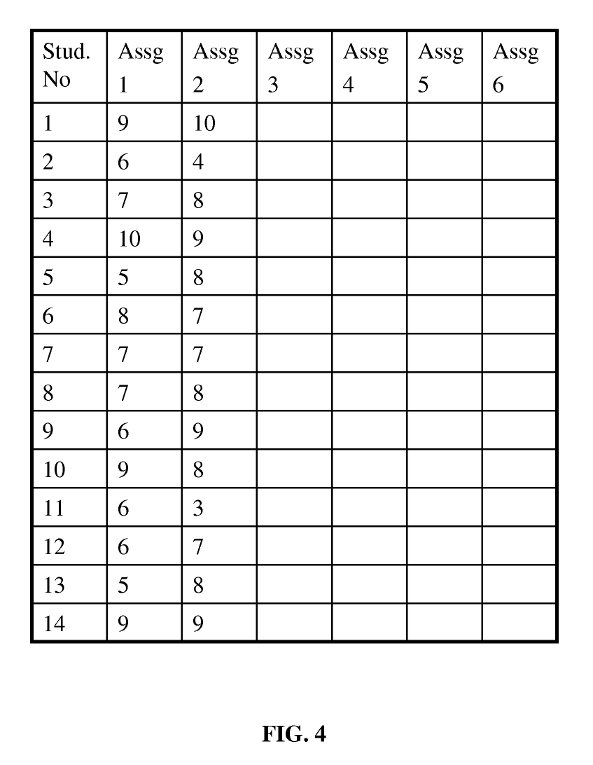

FIG. 4 illustrates a database maintained by the school server 24. The school server 24 can track the progress of a number of students in accordance with the present invention. In FIG. 4, there are fourteen students being tracked. During a semester, there will be six assignments, which could include homework, tests, worksheets, problem sets and the like. The first two assignments have been completed and every student has submitted a document through a personal computer 20 to the school server 24. Grades have been entered into the database of FIG. 4 for each student for each of the first two assignments. In this fashion, the progress of the students can be tracked by the school server 24.

The school server 24 can also submit documents to be stored on the memory 40 of the book 10. The server 24 would typically first transmit the documents to the personal computer 20, which would then transmit the documents to the memory 40 on the book 10. These documents could be comments from a teacher, progress reports or other communications to the student or owner of the book 10.

The owner of the book 10 can also connect to other servers 26 via the internet 22 to obtain further information about the subject of the book 10. The memory 40 may include a listing of sites and a link to those sites so that the book owner can easily access the sites by clicking on a document that has been transmitted from the memory 40 on the book 10 to the personal computer 20. The documents from various servers 26 can also be stored on the memory 40 of the book 10.

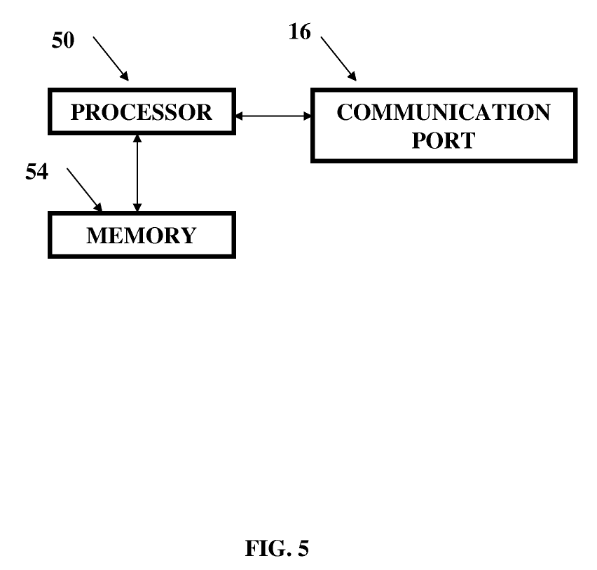

FIG. 5 illustrates another embodiment of a circuit that may be found on the book 10. This circuit includes the communication port 16 which is preferably a USB port. It also includes a processor 50 connected to the port 16 and a memory 54 connected to the processor 50. The memory 54 can store the previously referred to documents. It can also store application software that can be accessed by the processor 50. The application software can be downloaded to the personal computer 20 or processed by the processor 50. The memory 40 from FIG. 2 can also hold application software that can be downloaded to the personal computer 20.

The processor 50 is preferably located near the memory 54 and the connector 16. These components can be located in the same places as previously discussed with respect to the memory 40.

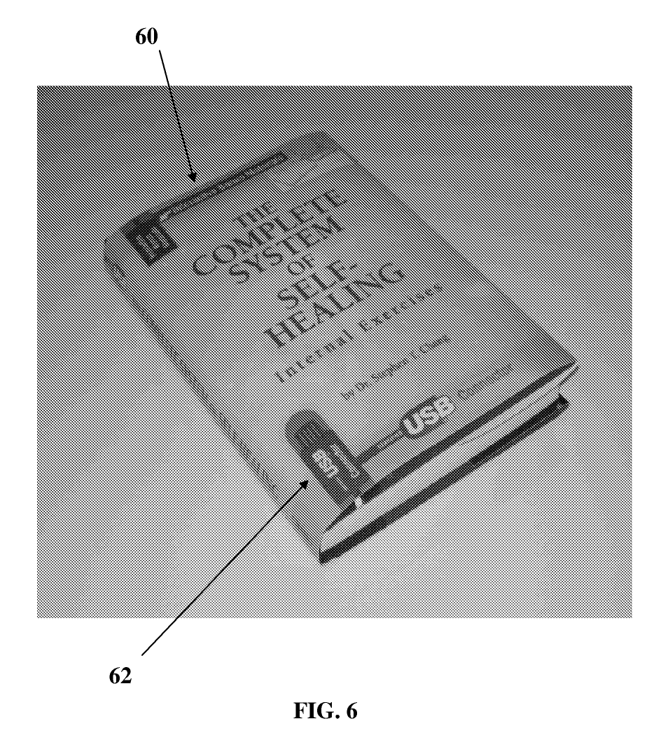

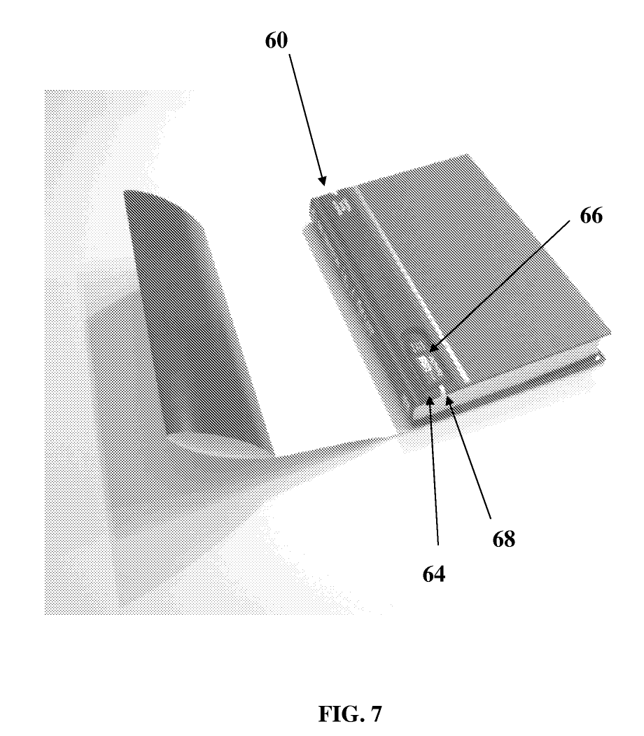

FIGS. 6 and 7 illustrate another aspect of the present invention. A book 60 has a cover and an indication 62 on the cover that the book 60 is a USB book. FIG. 7 illustrates the book 60 with the cover partially removed. The front cover of the book 60 has an indentation 64 that holds a USB device/jump drive 66 with a cord 68.

The indentation 64 can also be located in the back cover of the book 60. The indentation 64 can also be located in a special page of the book 60 or even in the spine of the book 60.

The indentation 64 preferably has two or more clips that hold the USB device/jump drive 66 in place. When the USB device/jump drive 66 is placed in the holder, the clips preferably engage the USB device/jump drive 66 to retain it in place.

Of course, an indentation does not have to be used, and any other holder can be used.

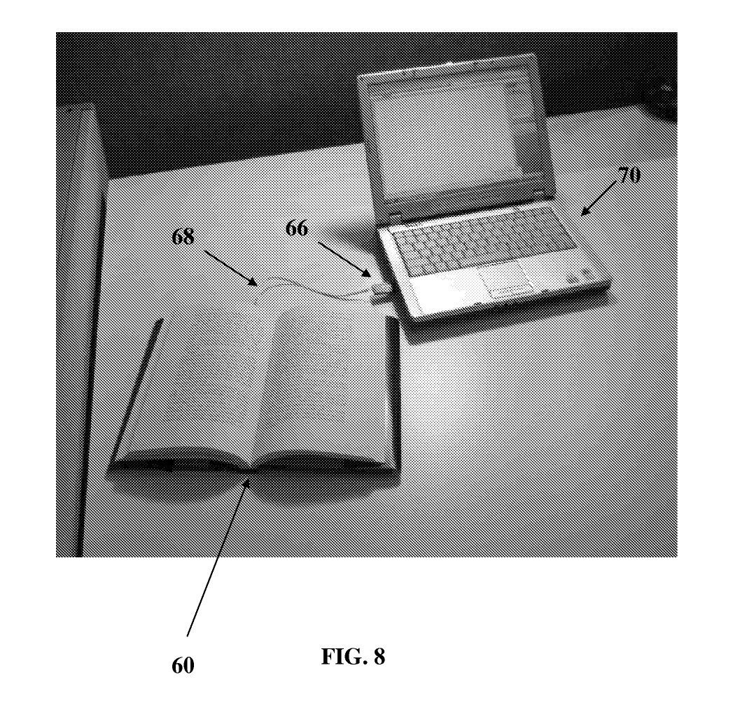

FIG. 8 illustrates the USB device/jump drive 66 connected to a laptop computer 70. The USB device/jump drive 66 has been removed from the holder 64 in the book 60 and inserted into a USB connector on the laptop computer 70. The cord 68 extends from the book 60. The cord 68 can be free from connection to the book 60, and in this case can actually be used as a book mark. Alternatively, the cord 68 can be connected at one end to the book 60 so that it is difficult to lose the USB device/jump drive 66. The connection to the book 60 can be made by glue or any other connection means. The cord 68 can also be held in a circularly wound position, held in place by a spring so that when the cord 68 is pulled out from the book 60 there is tension on the cord 68. The cord 68 can also provide an electrical connection to a processor on the book 60.

When the USB device/jump drive 66 is plugged into the laptop computer 70, the processor in the laptop computer 70 can execute the software application on the USB device/jump drive 66 to execute programs related to the book content. Documents can be downloaded onto the computer 70, links to web sties on the Internet can be made, documents from the computer 70 and web sites connected to the computer 70 can be downloaded to the flash drive 66, and an entire lesson plan can be implemented, as previously described.

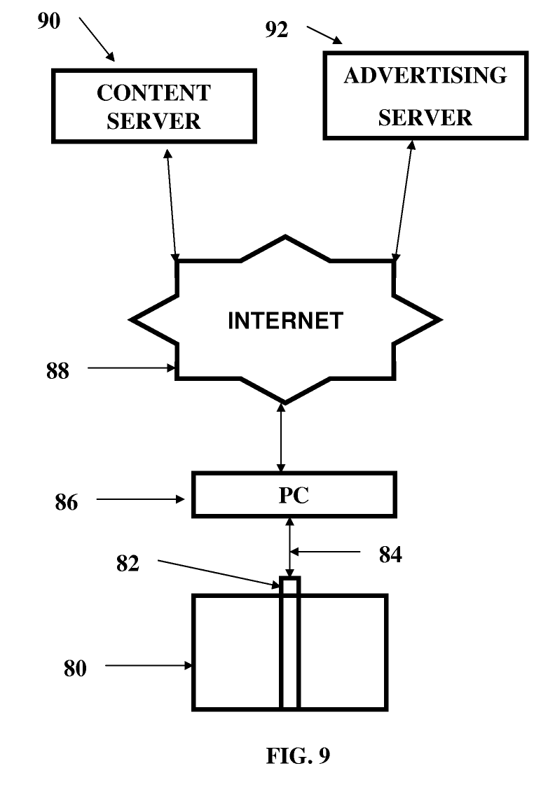

FIG. 9 illustrates another aspect of the present invention. A book 80 having a connection 82 to a computer 86 is illustrated. The connection 82 to the computer 86 is preferably a jump drive 84 that is attached by a string or other mechanism to the book 80 and that is plugged into a connector on the computer 86. Alternatively, the connection to the computer 86 can be via a USB connector on the book and a memory on the book can supply the information supplied hereinafter.

The computer 86 is connected to one or more content servers 90 and one or more advertising servers 92 via an Internet connection 88.

The jump drive 84 or the memory on the book 80 has information stored on it. In accordance with one aspect of the present invention, the information relates to the topic of the book. In accordance with another aspect of the present invention, an advertisement of a product or service related to the topic of the book is stored on the jump drive.

When the computer 86 is connected to the book 80, the information stored on the jump drive 84, or on a memory in the book 80, can be displayed on the computer. If the information is advertisements, then the advertisements can be displayed on the computer.

In accordance with another aspect of the present invention, the information on the jump drive 84 causes the computer 86 to connect to one of the servers 90 or 92. The information can be a program that is executed by the computer 86. The program has the web address for the server 90 or 92 being connected to and the computer 86, under control of the program on the storage media provided with the book 80, connects to the server under the program control.

In accordance with another aspect of the present invention, the server 90 or 92 downloads information stored on the server to the computer to be displayed by the computer. In the case of the content server 90, new content is downloaded from the server 90 to the computer 86 to be displayed on the computer 86. The new content is preferably related to the topic of the book 80 to enhance a reader's experience with the book 80. In the case of the advertising server 92, the new content downloaded from the advertising server 92 is advertisements. The advertisements preferably describe products or services related to the topic of the book 80.

The information stored on the server can be a list of a plurality of advertisements that can be selected for viewing. The list can be displayed on the computer 86 and one of the advertisements can be selected to be viewed on the computer 86. The advertisements stored on the server 92 can be periodically updated. Thus, advertisers wishing to update their advertisements can access the server 92 to store new advertisements on the server 92.

The advertisements stored on the server 92 can be pre-sold to manufacturers or service providers.

Of course, all of the information that is described as being on the servers 90 or 92 can be stored on the jump drive 84 or on a memory on the book 80.

The item 80 can be any printed publication. Thus, the item 80 can be a hard cover book, a soft cover book, a pocket edition book or a magazine, or any other printed publication. The description provided above with respect to the book also applies to these printed media. Thus, the jump drive 84 or other connector to memory on the media 80 can be stored on the spine of the media 80 or in the cover of the media 80 or on a special page in the media 80.

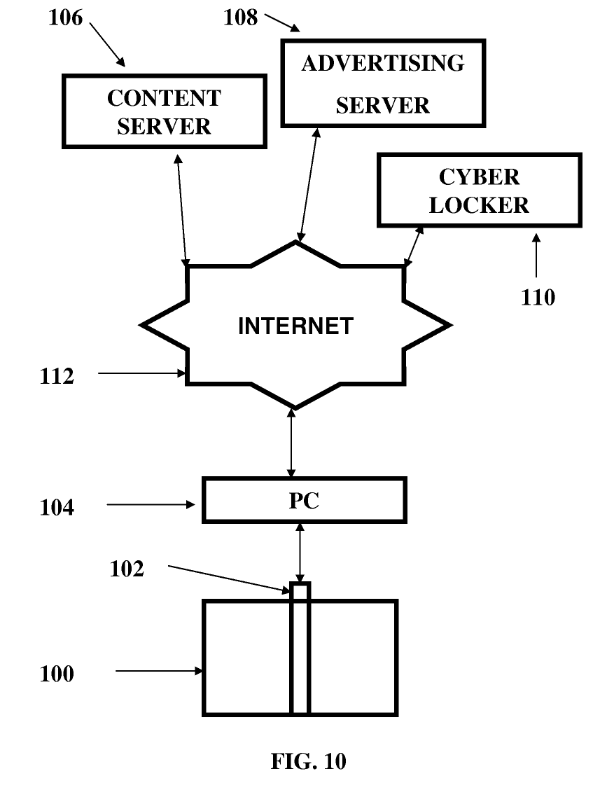

Referring now to FIG. 10, another aspect of the present invention is shown. A server 100 has an attached jump drive 102 connected to a computer 104. The computer 104 is connected to advertising servers 106, content servers 108 and a user's cyber locker space 110 through the internet 112.

In accordance with this aspect of the present invention, the jump drive 102 has a minimum amount of information stored on it. This allows the jump drive 102 to be provided with the smallest possible memory to allow it to be provided in a cost effective manner.

In accordance with one aspect of the present invention, the jump drive has a memory containing only information that is needed to allow the computer to connect to one or more servers. The memory on the jump drive is sized so that no additional information can be stored on it.

The information stored on the jump drive 102 can be a web address of a content server 108 on the internet that stores information related to the printed publication, as previously described. When the jump drive 102 is plugged into a computer 104, the computer uses the address on the jump drive to access the content server. In accordance with another aspect of the present invention. the program that enables the computer to connect to the content server using the web address can also be provided on the memory on the jump drive 102. In accordance with a further aspect of the present invention, a key that allows access to the content server can also be provided on the memory on the jump drive 102. The key is also stored on the content server 108 and when the computer 104 accesses the server 108, the keys are compared. If there is a match, then access is allowed to the content server 108.

Similar information about an advertising server 106 can also be stored on memory on the jump drive 102. This information concerning the advertising server 106 can be stored by itself on the jump drive 102 or can be stored on the jump drive 102 with the information related to the content server 108. The information stored on the jump drive, in accordance with one aspect of the present invention, can be a web address of a content server 108 on the internet that stores information related to the printed publication, as previously described. When the jump drive 102 is plugged into a computer 104, the computer uses the address on the jump drive to access the advertising server. In accordance with another aspect of the present invention. the program that enables the computer to connect to the advertising server 106 using the web address can also be provided on the memory on the jump drive 102. In accordance with a further aspect of the present invention, a key that allows access to the advertising server 106 can also be provided on the memory on the jump drive 102. The key is also stored on the advertising server 106 and when the computer 104 accesses the server 106, the keys are compared. If there is a match, then access is allowed to the advertising server 106.

In accordance with another aspect of the present invention, the jump drive 102 can also store information relating to a person's personal memory space 110 on the internet 112. The space 110 is referred to as a Cyber Locker storage. This memory space is commonly provided to users of an internet service, but can also be part of a paid for service.

The information relating to a person's personal memory space 110 can include the web address of the memory space 110 on the internet 112. The information can also include a program that causes the computer 104 to query a user to enter the web address of the memory space 110. Thus, when the jump drive 102 is removed from the printed publication 100 and inserted into the computer 104, the computer will prompt the user to enter the web address, which will then be stored on the jump drive 102.

The information stored on the jump drive relating a person's personal memory space 110 can also include a key that permits access to the personal memory space 110. The key can be specified by a user on the computer 104 and then stored on the jump drive 102. The key can be used by the computer 104 when accessing the personal memory space 110 to allow access to the personal memory space 110 by comparing the key stored on the jump drive 102 to the key stored by the personal memory space 110. If there is a match, then access is allowed.

The reader of the printed publication 100 can store information from the content server 108 or the advertising server 106 onto the personal memory space 110 on the internet 112. This can be done using the address information concerning the personal memory space 112 that is stored on the jump drive 102. Alternatively, the user can enter the information if it is not stored on the jump drive 102.

Of course, if the size of the memory on the jump drive 102 is not an issue, then any or all of the above mentioned information can be stored on the jump drive 102. In this case, additional information can also be stored. For example, if the printed publication is a monthly sports magazine, highlights from the past month of sports can be stored on the jump drive 102, for example, in MPEG format. Then when the jump drive 102 is removed from the printed publication 100 and inserted into a USB connector on the computer 104, the computer 104 can display the highlights.

In accordance with another aspect of the present invention, the key stored on the jump drive 102 can unlock a “group of lockers” defined by the parameters of the book content as well as advertising. In this case, the group of lockers can be represented by a group of servers 106 and 108.

However, when the user wants to SAVE something in a locker, that locker is individually assigned to the particular key, and the addition to the key is stored on the USB flash drive. Therefore, in the future, when using the key stored on the USB flash drive, the locker with stored information can be opened from any location. Then the locker contains not only supplemental information from content servers and the advertising from advertising servers, but the user's own input as well.

All of the functions described herein can be performed by storing the appropriate data and the appropriate program on the jump drive 102.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. An article that can be connected to a computer, comprising:
a printed publication;
a jump drive connected to the book; the jump drive having a memory containing only information that is needed to allow the computer to connect to one or more servers.

2. The article of claim 1, wherein the server is a content server that stores information related to the printed publication and the information on the jump drive is a web address of the content server.

3. The article of claim 1, wherein the server is a content server that stores information related to the printed publication and the information on the jump drive is a web address of the content server and a program that enables the computer to connect to the content server using the web address.

4. The article of claim 1, wherein the server is a content server that stores information related to the printed publication and the information on the jump drive is a web address of the content server, a key that allows access to the content server, and a program that enables a computer to connect to the content server using the web address.

5. The article of claim 1, wherein the server is an advertising server that stores advertising information related to the printed publication and the information on the jump drive is a web address of the advertising server.

6. The article of claim 1, wherein the server is an advertising server that stores advertising information related to the printed publication and the information on the jump drive is a web address of the advertising server and a program that enables a computer to connect to the advertising server using the web address.

7. The article of claim 1, wherein the server is an advertising server that stores advertising information related to the printed publication and the information on the jump drive is a web address of the advertising server, a key that allows access to the advertising server, and a program that enables a computer to connect to the advertising server using the web address.

8. The article of claim 3, wherein the server is an advertising server that stores advertising information related to the printed publication and the information on the jump drive is a web address of the advertising server.

9. The article of claim 3, wherein the server is an advertising server that stores advertising information related to the printed publication and the information on the jump drive is a web address of the advertising server and a program that enables a computer to connect to the advertising server using the web address.

10. The article of claim 3, wherein the server is an advertising server that stores advertising information related to the printed publication and the information on the jump drive is a web address of the advertising server, a key that allows access to the advertising server, and a program that enables a computer to connect to the advertising server using the web address.

11. The article of claim 1, wherein a memory on the jump drive is sized to be able to only store the information that is needed to allow the computer to connect to one or more servers.

12. The article of claim 1, wherein the printed publication is a book.

13. The article of claim 1, wherein the printed publication is a magazine.

14. The article of claim 1, wherein the information on the jump drive also includes an address of a user's memory space on an internet site.

15. The article of claim 14, wherein the information on the jump drive also includes a key that permits access to the user's memory space.

16. The article of claim 3, wherein the information on the jump drive also includes an address of a user's memory space on an internet site.

17. The article of claim 16, wherein the information on the jump drive also includes a key that permits access to the user's memory space.

18. The article of claim 7, wherein the information on the jump drive also includes an address of a user's memory space on an internet site.

19. The article of claim 18, wherein the information on the jump drive also includes a key that permits access to the user's memory space.
